(19) United States
(12) Patent Application Publication
(10) Pub. No.: US 2008/0001769 A1
(43) Pub. Date: Jan. 3, 2008

(54) Method and Apparatus for Contact-less Testing of RFID Straps

(75) Inventors: Juergen Mayer-Zintel, Allershausen (DE); Enn Leong Tan, Melaka (MY); Konstantin Aslanidis, Dachau (DE)

Correspondence Address: TEXAS INSTRUMENTS INCORPORATED, P O BOX 655474, M/S 3999, DALLAS, TX, 75265, US

(73) Assignee: TEXAS INSTRUMENTS, DEUTSCHLAND GMBH, Freising (DE)

(21) Appl. No.: 11/766,978

(22) Filed: Jun. 22, 2007

Related U.S. Application Data
(63) Continuation of application No. PCT/EP05/13912, filed on Dec. 22, 2005.

(30) Foreign Application Priority Data
Dec. 22, 2004 (DE) 10 2004 061918.2

(51) Int. Cl. G08B 21/00

(52) U.S. Cl. 340/653

(57) ABSTRACT

A method and apparatus for batch testing of RFID straps are provided. The RFID straps are arranged on a carrier web in a closely spaced relationship, where each strap includes two terminal pads exposed on the carrier web and an RFID chip. The carrier web is moved so as to align all straps in a batch with corresponding test probes of a test equipment. Each test probe is moved transversely to the moving direction of the carrier web into close proximity with a corresponding strap. A capacitive coupling is established between test electrodes on each test probe and the terminal pads of a corresponding strap. Test signals are then transmitted from each test probe to a corresponding strap, and response signals are received at each test probe from a corresponding strap for evaluation by the test equipment.

### FIELD OF THE INVENTION

The present invention relates to a method and apparatus for batch testing of RFID straps arranged on a carrier web in a closely spaced relationship.

### BACKGROUND OF THE INVENTION

RFID tags consist of a chip (integrated circuit) and a planar antenna. The chip is carried on a strap for attachment on an antenna. As used herein, an RFID strap is an arrangement of two or more terminal pads on a foil such as a PET foil or paper and an RFID chip mounted on the foil and having contact bumps each in electrical contact with one of the terminal pads. In mass production of these tags, the straps are assembled with the antennas in a final bonding step. Prior to the final bonding step, the chips must be tested. In the case of RFID tags operating in the UHF frequency range, the antennas and the terminal pads of the straps are very small. Conventionally, the terminal pads of each strap are contacted with a pair of needle electrodes of a test probe. For high volume production, the handling of test fixtures with contacting test electrodes such as needles is a severe throughput limitation. Contact-less testing by RF radiation is possible, but simultaneous batch testing of multiple tags would require complex shielding techniques due to the crosstalk between the units under test.

### SUMMARY OF THE INVENTION

An aspect of the present invention provides a method and apparatus for contactless testing of RFID straps and, in particular, RFID chips for the UHF frequency range. The basic idea of the invention is to use capacitive coupling between each test probe and a strap under test. This approach avoids crosstalk between the chips under test and permits batch testing, i.e. simultaneous testing of multiple chips. With the inventive method and apparatus, multiple straps can be tested in a very short period of time. For example, in a practical implementation of the invention, each batch may comprise 32 straps, and each batch is tested in about 50 ms including an indexing step of the carrier web. Even larger batches and shorter test times are envisioned.

An aspect of the invention provides a method of batch testing RFID straps arranged on a carrier web in a closely spaced relationship, where each strap includes a circuit part with two terminal pads exposed on the carrier web and an RFID chip mounted on the web so as to have its contact bumps in electrical contact with the terminal pads. The carrier web is moved so as to align all straps in a batch with corresponding test probes of a test equipment. Each test probe is moved transversely to the moving direction of the carrier web into close proximity with a corresponding strap. A capacitive coupling is established between test electrodes on each test probe and the terminal pads of a corresponding strap. Test signals are then transmitted from each test probe to a corresponding strap, and response signals are received at each test probe from a corresponding strap for evaluation by the test equipment.

An aspect of the invention also provides an apparatus for batch testing RFID straps arranged on a carrier web in a closely spaced relationship, each strap including a circuit part with a pair of terminal pads exposed on the carrier web and an RFID chip with contact bumps connected to the terminal pads. The apparatus includes a test equipment with a test head that has a plurality of test probes arranged in an array corresponding to an array of straps in a batch on the carrier web. Each test probe has a pair of test electrodes adapted to be aligned with the terminal pads of a corresponding strap. The apparatus further includes means for indexing the carrier web so as to successively expose batches of straps to the test head, and means for moving the test head transversely to the moving direction of the carrier web into close proximity with the straps on the carrier web so as to establish a capacitive coupling between each pair of test electrodes in a test probe and a pair of terminal pads of a corresponding strap.

Further details of the invention appear from the dependent claims and from the following description with reference to the appending drawings.

### BRIEF DESCRIPTION OF THE DRAWINGS

FIG. 1 is a schematic side view of an RFID tag batch testing arrangement according to a first embodiment;

FIG. 2 is an enlarged schematic side view of a single unit under test in the first embodiment;

FIG. 3 is a schematic side view of an RFID tag batch testing arrangement according to a second embodiment;

FIG. 4 is an enlarged schematic side view of a single unit under test in the second embodiment;

FIG. 5 is a circuit diagram illustrating the matching between a tag under test and a test head;

FIG. 6 is a schematic plan view of a single RFID strap;

FIG. 7 is a schematic side view of the RFID strap; and

FIG. 8 is a schematic plan view of a carrier web with parallel rows of closely spaced straps thereon;

### DETAILED DESCRIPTION

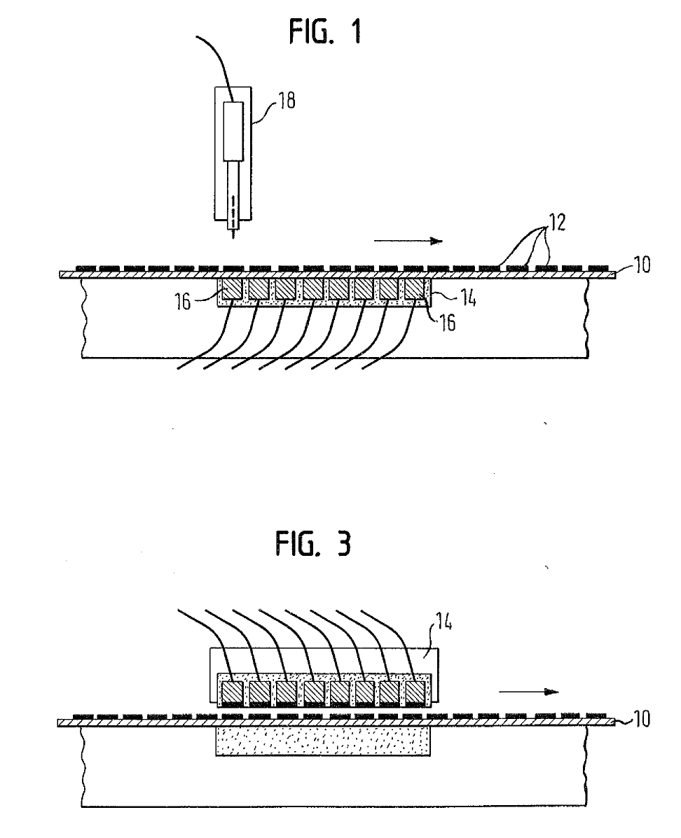

In FIG. 1, a horizontal web 10 carries multiple closely spaced RFID straps 12 which are aligned in a row or, preferably, in multiple rows. The web may be a strap foil of PET. A test head 14 includes multiple test probes 16 placed against the web 10 from beneath. The test probes 16 are arranged in test head 14 in an array that corresponds to the arrangement of the RFID straps 12 on web 10 so that each test probe 16 can be vertically aligned with a corresponding strap 12. Each test probe has a lead for connection to a common test equipment (not shown). An inking device 18 is provided to selectively mark individual straps that would not have passed a test. By applying a vacuum between the web 10 and the test head 14 the web is fixed against accidental movement and any air cushion between the test head and the web is removed to ensure reproducible test results.

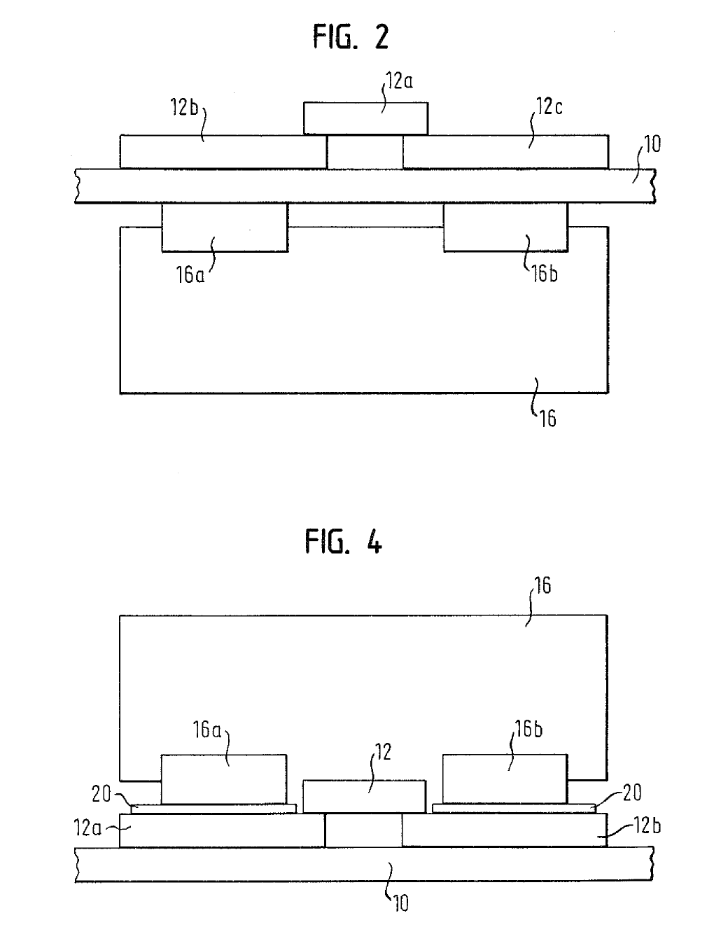

With reference to FIG. 2, each RFID strap 12 comprises a chip 12a, a first terminal pad 12b and a second terminal pad 12c, both intended for the final connection to an antenna of an RFID tag. The test probe 16 has a first test electrode 16a and a second test electrode 16b. Both test electrodes 16a, 16b are applied against the lower face of web 10 in vertical alignment with the corresponding terminal pads 12b, 12c. The web forms a dielectric between electrodes 16a, 16b and pads 12b, 12c. To eliminate residual air between the lower face of web 10 and the faces of test electrodes 16a, 16b, the test head may be pressed against web 10. Alternatively, the residual air is removed by some aspiration means (not shown). A capacitive coupling is established between each test head 14 and a corresponding strap 12 by virtue of the capacitance formed between each test electrode and terminal pad. In this embodiment, the inking device 18 (or any other marking device) does not require additional space as it is placed directly over the test head.

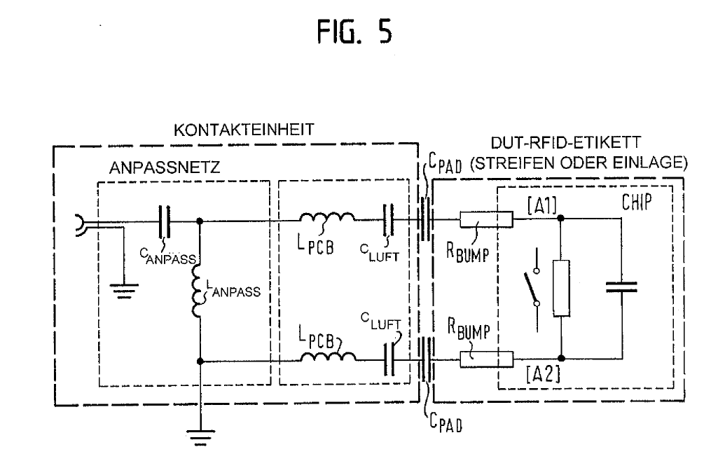

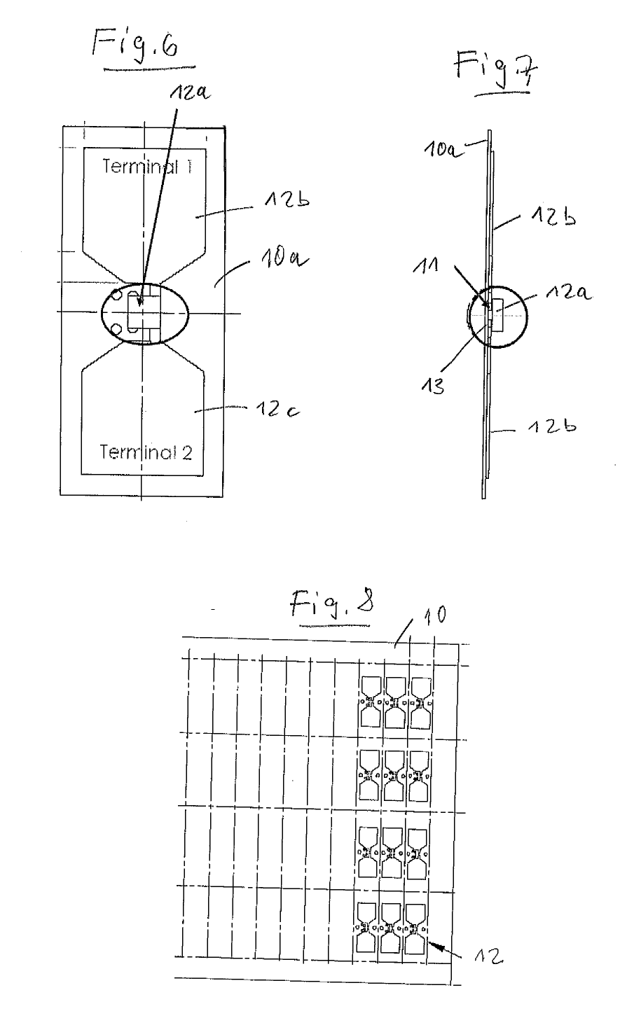

In the embodiment of FIGS. 3 and 4, the test head 14 is arranged above web 10 and is lowered so as to place the test electrodes 16a, 16b immediately above the corresponding terminal pads 12b, 12c. To avoid a direct contact, a foil 20 of a dielectric material is interposed between the electrodes 16a, 16b and the pads 12b, 12c. The remaining arrangement is the same as in the preceding embodiment. Therefore, the coupling capacity between the test electrodes 16a, 16b and the terminal pads 12b, 12c is now independent of the material and thickness of the web 10. This allows a greater flexibility on the used web material as the matching network can remain unchanged. In this embodiment, residual air between the web 10 and the test head 14 is removed by pressing the head onto the web.

As seen in FIG. 5, a RFID strap under test (DUT, device under test) is equivalent to a circuit with an internal capacitance and (switched) resistor and includes series resistors RBump corresponding to the bump contact resistance of the chip. In the case of UHF tags that have a low Q value on the order of 5, these contact resistances can be neglected. The capacitance between each electrode-pad pair is represented by a capacitor CPAD. The interface between the strap and the test probe is represented by series-connected inductive and capacitive elements LPCB and CAir. The test probe 14 has a matching network that consists of series capacitor Cmatch and a parallel inductor Lmatch. It should be understood that these capacitive and inductive elements are indicated symbolically, as actual implementations may be more complex. In the embodiment of FIG. 3, the matching network of the test head 14 is independent of the used web material (PET, paper, . . . ) and thickness.

With reference to FIG. 6 and FIG. 7, an RFID strap consists of a rectangular foil 10a (which may actually be a cut section of carrier web 10) that has terminal pads 12b and 12c formed thereon, and the RFID chip 12a. Chip 12a is mounted on foil 10a with each of its contact bumps 11, 13 in electrical contact with one of the terminal pads 12b, 12c (designated in FIG. 6 as “Terminal 1” and “Terminal 2”). As shown in FIG. 6 and FIG. 7, an RFID strap after separation from the carrier web 10 is ready for attachment and connection to an antenna circuit. The antenna circuit with the RFID strap together form an RFID tag.

FIG. 8 shows four parallel rows of closely spaced RFID straps 12 on carrier web 10.

In operation, a batch of RFID straps 12, for example 32 straps in the four parallel rows on web 10, are presented simultaneously to the test head 14, and each test probe 16 is capacitively coupled with the aligned terminal pads 12b, 12c of a strap 12. Test signals are simultaneously sent from each test probe 16 to a corresponding strap 12, and response signals are received in the test probes from the straps for evaluation by the common test equipment. Any RFID strap that has not passed the test would be marked, such as by applying an ink spot with an inking device 18 or by punching. After a batch test is completed, the web 10 is indexed to present a next batch of tags to test head 14. The testing process is preferably incorporated on-line in the RFID tag production line since testing with the inventive method is fast enough.

To avoid or at least reduce any crosstalk effects, units not under test are disabled by short-connecting the corresponding terminals 16a and 16b of test head 14. The strap will not respond, and no energy is injected. In addition, an interlaced test structure is preferably used to increase the distance between the units under test.

While the invention has been particularly shown and described with reference to preferred embodiments thereof it is well understood by those skilled in the art that various changes and modifications can be made in the invention without departing from the spirit and scope of the invention as defined by the appended claims.

1. A method of batch testing RFID straps arranged on a carrier web in a closely spaced relationship, each RFID strap including at least two terminal pads exposed on the carrier web and an RFID chip with contact bumps each connected to one of the terminal pads, comprising the steps of
moving the carrier web so as to align all RFID straps in a batch with corresponding test probes of a test equipment,
moving each test probe transversely to the moving direction of the carrier web into close proximity with a corresponding RFID strap,
establishing a capacitive coupling between test electrodes on each test probe and the terminal pads of a corresponding RFID strap,
transmitting test signals from each test probe to a corresponding RFID strap, and receiving response signals at each test probe from a corresponding RFID strap.

2. The method of claim 1, wherein the carrier web is indexed to successively present each batch of RFID straps to the test probes of the test equipment.

3. The method of claim 1, wherein the RFID straps in each batch are tested simultaneously.

4. The method of according to claim 1, wherein a strap that has not passed a test is marked.

5. The method of claim 4, wherein the strap is marked by inking.

6. The method of claim 4, wherein the strap is marked by punching.

7. The method of according to claim 1, wherein the test probes are moved with said test electrodes into contact with a face of the carrier web opposite a face on which the straps are attached, the carrier web being used as a dielectric.

8. The method of according to to claim 1, wherein the test probes are moved with said test electrodes against the terminal pads of the straps and a dielectric foil is interposed between each test electrode and each terminal pad.

9. The method of claim 7, wherein residual air between the test electrodes and the terminal pads is removed by aspiration.

10. The method according to to claim 1, wherein the test probes are capacitively and inductively matched with an equivalent circuit represented by each of the RFID straps.

11. Apparatus for batch testing RFID straps arranged on a carrier web in a closely spaced relationship, each RFID strap including a pair of terminal pads exposed on the carrier web and an RFID chip with contact bumps each connected to one of said terminal pads, comprising:
a test head that has a plurality of test probes arranged in an array corresponding to an array of RFID straps in a batch on the carrier web, each test probe having a pair of test electrodes adapted to be aligned with the terminal pads of a corresponding RFID strap;
means for indexing the carrier web so as to successively expose batches of RFID straps to the test head; and
means for moving the test head transversely to the moving direction of the carrier web into close proximity with the RFID straps on the carrier web so as to establish a capacitive coupling between each pair of test electrodes in a test probe and a pair of terminal pads of a corresponding RFID strap.

12. The apparatus of claim 11, wherein the carrier web is made of a dielectric material and the test head is adapted to be moved against a face of the carrier web opposite a face that carries the RFID straps.

13. The apparatus of claim 11, wherein the test head is adapted to be moved against a face of the carrier web that carries the RFID straps, and wherein a dielectric foil is interposed between each pair of test electrodes and a corresponding pair of terminal pads.

14. The apparatus of claim 12, comprising aspirating means for removing residual air between the test head and the carrier web.

15. The apparatus of claim 13, comprising aspirating means for removing residual air between the test head with the dielectric foil and the exposed terminal pads of the tags.

16. The apparatus of claim 11, comprising an inking device for selectively marking an RFID strap that has not passed a test.

17. The apparatus of claim 11, comprising a stamping device for selectively marking an RFID strap that has not passed a test.

18. The apparatus of claim 11, wherein each test probe includes a matching circuit with at least a capacitive element and an inductive element for capacitive and inductive matching with an equivalent circuit represented by each RFID strap.

19. The apparatus of claim 12 wherein each test probe includes a matching circuit with at least a capacitive element and an inductive element for capacitive and inductive matching with an equivalent circuit represented by each RFID strap.

20. The apparatus of claim 13, wherein each test probe includes a matching circuit with at least a capacitive element and an inductive element for capacitive and inductive matching with an equivalent circuit represented by each RFID strap.
